(19) United States
(12) Patent Application Publication
(10) Pub. No.: US 2010/0224805 A1
(43) Pub. Date: Sep. 9, 2010

(54) HYDRAULIC ACTUATING DEVICE

(75) Inventor: Jean-Claude Oury, Artas (FR)

Correspondence Address: YOUNG & THOMPSON, 209 Madison Street, Suite 500, Alexandria, VA, 22314, US

(73) Assignee: SANITAIRE ACCESSOIRES SERVICES S.A.S., Saint Laurent De Mure (FR)

(21) Appl. No.: 12/161,801

(22) PCT Filed: Jan. 23, 2007
(86) PCT No.: PCT/FR07/00127

§ 371 Date: Jan. 30, 2009

(30) Foreign Application Priority Data
Jan. 24, 2006 (FR) 0600610

(51) Int. Cl. F16K 31/12

(52) U.S. Cl. 251/58

(57) ABSTRACT

Hydraulic actuating device (1) for actuating a water evacuation mechanism (2), includes: an actuating unit (4) with plunger(s),
a control unit (5) that can be integrated with the actuating unit,
at least one three-way hydraulic valve (6) supplied by a water distribution system and
controlled by the control unit (5), and
at least one single-action hydraulic jack (3) supplied via the valve and ensuring the
triggering of the water evacuation mechanism by raising a closing flap (56) or a plug.

The object of this invention is a hydraulic actuating device.

Hydraulic actuating devices are used to actuate emptying mechanisms. The invention is well suited, although not limited, to controlling a sanitary flushing mechanism.

The known actuating devices for actuation of flushing mechanisms generally use rod or cable or pneumatic transmission systems. Rod transmission systems have the drawback of being difficult to adjust. Cable transmission systems have the drawback that they necessitate observance of tolerances that are difficult to maintain. Pneumatic transmission systems have the drawback of being cumbersome to use. All of these systems, moreover, require high pressure on the actuating button(s) for initiation of emptying.

Document U.S. Pat. No. 2,838,765 discloses a water evacuation and refilling device that comprises a mechanical actuation that operates manually and that acts directly on a hydraulic valve of said device.

This device likewise has the drawback of requiring high pressure on the control button or buttons and of being unsightly.

The object of this invention is to suggest a hydraulic actuating device that avoids at least some of the aforementioned drawbacks and that allows limitation of the pressure that the user must apply to the plunger(s) to initiate emptying.

For this purpose, the object of the invention is a hydraulic actuating device for actuating a water evacuation mechanism, said hydraulic actuating device comprising an actuating unit with plunger(s), characterized in that it comprises:
a control unit that can be integrated with the actuating unit,
at least one three-way hydraulic valve supplied by a water distribution system and controlled by the control unit, and
at least one single-action hydraulic jack supplied via the valve and ensuring the triggering of said water evacuation mechanism by raising a closing flap or plug.

Advantageously, said hydraulic valve comprises an entry channel designed to be connected to said water distribution system, an exit channel designed to be connected to the chamber of said hydraulic jack, and an exhaust channel, said hydraulic valve comprising a valve that can move between a first position in which it allows the circulation of water from said exit channel toward said exhaust channel, and a second position in which it allows the circulation of water from said entry channel to said exit channel, said hydraulic jack being able to ensure the raising of said closing flap or plug when said flap is in said second position.

Preferably, said entry channel supplies the actuating channel of said hydraulic valve via a gauge, said actuating channel being designed to be connected to the actuating pipe of said hydraulic actuating device, said plunger being able to move between a rest position in which the water contained in said actuating pipe can apply to said flap a pressure sufficient to keep said flap in the first position, and an operating position in which at least a portion of the water contained in said actuating pipe is evacuated from said actuating pipe to allow displacement of said flap to the second position.

Advantageously, said actuating device comprises an actuating rod, said plunger having an extension supported on one end of the actuating rod, said actuating rod being elastically pushed toward a rest position corresponding to the rest position of said plunger, said actuating rod being integral in translation with an operating flap, said operating flap being arranged to prevent evacuation of water from a passage discharging into said actuating pipe when said actuating rod is in the rest position and to allow evacuation of the water from said passage when said actuating rod is in said operating position.

Preferably, said actuating channel discharges into a first recess of a valve body of said hydraulic valve, an elastic membrane being located in the recess so as to separate the actuating channel from the entry, exit and exhaust channels, one end of said gauge being housed in an orifice of said membrane.

According to one embodiment of the invention, said flap is integral with the gauge, the flap being movable into a second recess of the valve body into which the entry, exit and exhaust channels discharge, the flap in the first position being supported on a first edge so as to prevent the circulation of water between the entry channel and said second recess, and in the second position being supported on a second edge so as to prevent the circulation of water between said second recess and the exhaust channel.

According to one embodiment of the invention, said hydraulic actuating device is used to actuate a sanitary flushing mechanism.

Advantageously, said flushing mechanism is a double-flushing mechanism, said hydraulic actuating device comprising a second three-way hydraulic valve supplied by said water distribution system and controlled by said control unit, the actuating unit comprising two plungers, each actuating one of the hydraulic valves, said hydraulic actuating device comprising a second, single-action hydraulic jack supplied via said second flap and ensuring the triggering of said water evacuation mechanism by raising said closing flap, said second jack comprising a piston with a stroke different from the stroke of the piston of said jack, in such a way that the closing flap is raised by a different height when it is raised by said second jack and when it is raised by said jack.

According to one embodiment of the invention, said hydraulic actuating device is used to actuate a mechanism for emptying a basin, such as a bathtub, a washbasin, a bidet or a sink.

The invention will be better understood, and other objectives, details, characteristics and advantages of the latter will become more apparent by way of the following, detailed explanatory description of one embodiment of the invention given by way of purely illustrative and nonlimiting example, with reference to the attached diagrammatic drawings.

In these drawings:

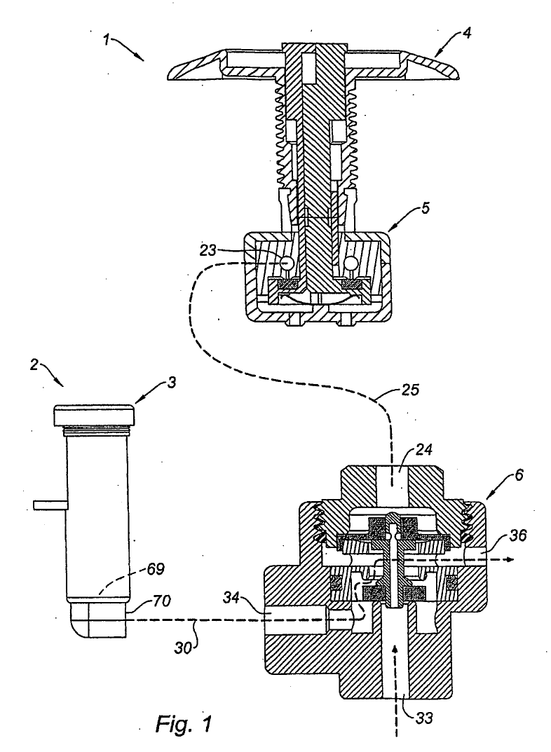

FIG. 1 is a simplified diagrammatic view of a hydraulic actuating device according to one embodiment of the invention;

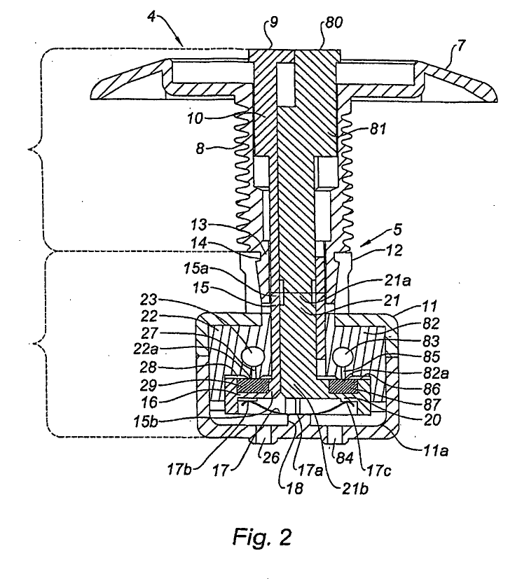

FIG. 2 is a simplified diagrammatic view of a longitudinal section of the actuating unit and the control unit of the hydraulic actuating device of the figure;

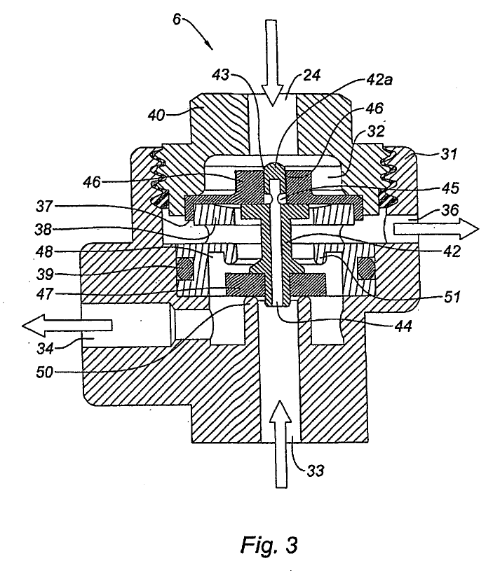

FIG. 3 is a simplified diagrammatic view of a longitudinal section of the valve of the hydraulic actuating device of FIG. 1;

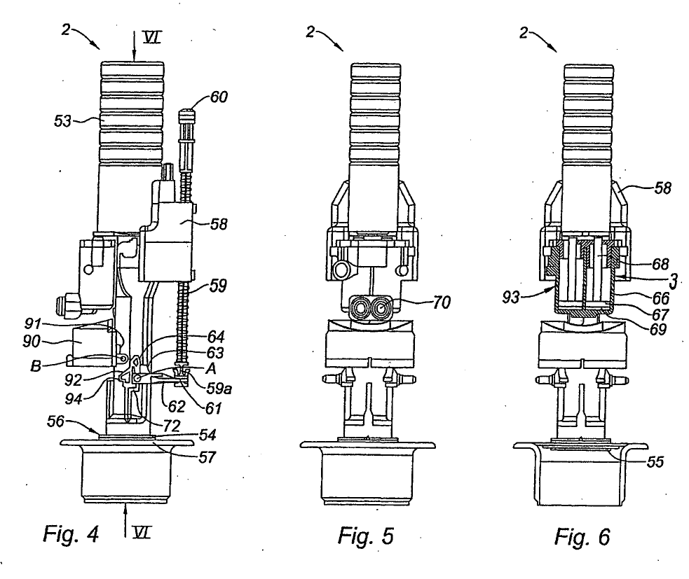

FIG. 4 is a simplified diagrammatic front view of a flushing mechanism actuated by the hydraulic actuating device of FIG. 1;

FIG. 5 is a simplified diagrammatic side view of the flushing mechanism of FIG. 4;

FIG. 6 is a simplified diagrammatic view of the flushing mechanism of FIG. 4 in a section along line VI-VI;

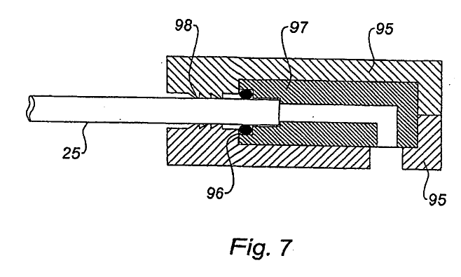

FIG. 7 is a simplified diagrammatic view in a longitudinal section of a pipe joint of the hydraulic actuating device;

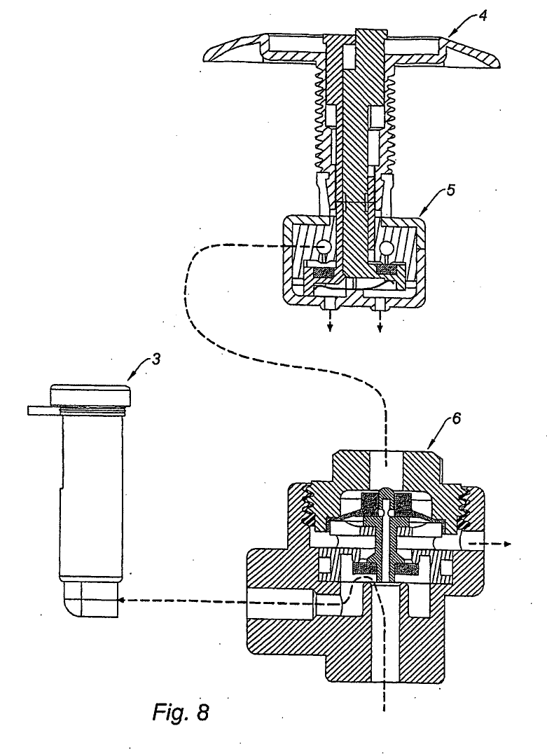

FIG. 8 is a view similar to FIG. 1, a plunger of the hydraulic actuating device being in the operating position;

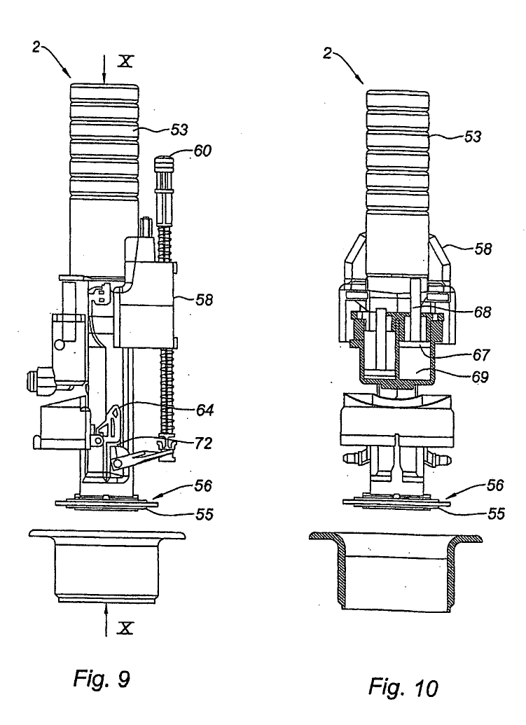

FIG. 9 is a view similar to FIG. 4, showing the flushing mechanism when it is actuated by the plunger;

FIG. 10 is a view of the flushing mechanism of FIG. 9 in a section along line X-X;

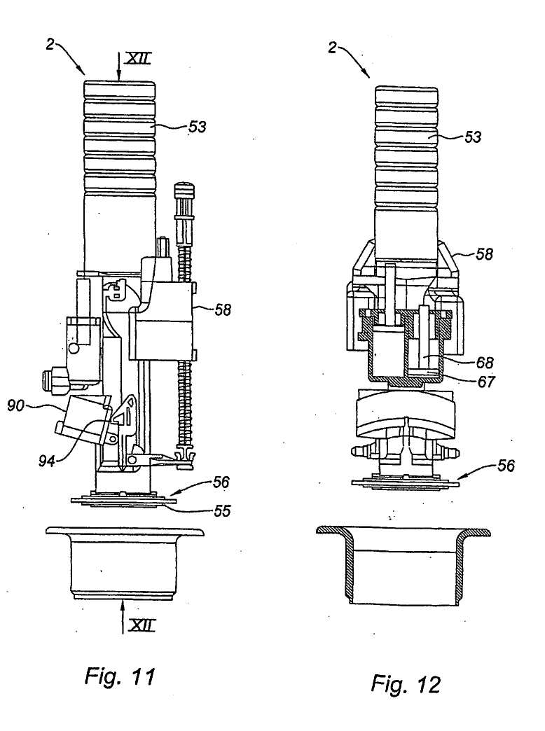

FIG. 11 is a view that is similar to FIG. 4, showing the flushing mechanism when it is actuated by a second plunger of the hydraulic actuating device; and

FIG. 12 is a view of the flushing mechanism from FIG. 11 in a section along line XII-XII.

With reference to FIG. 1, a hydraulic actuating device 1 is shown that allows actuation of a flushing mechanism 2. In FIG. 1, only one single-action hydraulic jack 3 of the flushing mechanism 2 was shown. The actuating device 1 comprises an actuating unit 4, a control unit 5, and a valve 6.

With reference to FIG. 2, the actuating unit 4 and the control unit 5 will now be described in greater detail.

The actuating unit 4 comprises a rosette 7 that is housed in an opening of a cover or of a flushing tank (not shown) and that is screwed by a threaded projection 8 onto a flushing nut (not shown). Such a rosette is known in the art.

The actuating unit 4 includes a plunger 9 comprising an axial extension 10 that can slide in the threaded projection 8. According to one implementation variant that is not shown, the plunger 9 can be actuated by a push button, a flexible membrane, or another piece of covering.

The control unit 5 includes a box 11 comprising a collar 12 that, for example, has an essentially cylindrical shape. The collar 12 has an annular excrescence 13, projecting radially to the inside. The excrescence 13 can work with an annular groove 14 for ratcheting the threaded projection 8. The rosette 7 is thus inserted into the collar 12 by elastic deformation, then ratcheted.

Within the box 11, an actuating rod 15 is housed. The actuating rod 15 comprises one end 15a supported against the lower side of the extension 10. The opposite end 15b of the actuating rod 15 comprises an elbow 16 that extends toward the periphery of the box 11.

A leaf 17 that forms a spring is located between the lower surface 11a of the box 11 and the elbow 16 for pushing the rod 15, thus the extension 10, toward a rest position in which the plunger 9 projects from the rosette 7. The leaf 17 is made of, for example, steel or plastic. The central part 17a of the leaf 17 is supported, in the embodiment shown, on an excrescence 18 of the lower surface 11a of the box 11. One end 17b of the leaf 17 is supported on the elbow 16. The opposite end 17c of the leaf 17 is supported on an elbow 20 of an actuating rod 21 whose operation will be described in detail below.

The control unit 5 comprises a seat support 22 that bears a seat 22a. The seat support 22 comprises a passage 23. The passage 23 is connected to an actuating channel 24 (FIG. 1) of the valve 6 by an actuating pipe 25, which is symbolized by broken lines in FIG. 1. The passage 23 is able to communicate with an evacuation hole 26 of the lower surface 11a of the box 11 via a groove 27 that discharges into the seat 22a. The evacuation hole 26 discharges, for example, into a flush tank (not shown).

The elbow 16 comprises a recess 28, located to the right of the groove 27, in which a flap 29 is housed. In the rest position, the leaf 17 keeps the elbow 16 in the up position. In this position, the flap 29 is supported against the groove 27 and blocks communication between the passage 23 and the evacuation hole 26.

With reference to FIG. 3, the valve 6 will now be described in more detail.

The valve 6 comprises a valve body 31. The actuating channel 24 discharges into a recess 32 of the valve body 31.

The valve 6 comprises an entry channel 33 that is connected to water supply means (not shown). The valve 6 comprises an exit channel 34 that is connected to a chamber 69 (FIG. 1) of the jack 3 by a pipe 30, which is symbolized by broken lines in FIG. 1. The valve 6 comprises an exhaust channel 36, which discharges, for example, into the flush tank.

An elastic membrane 37 is arranged in the recess 32 so as to separate the actuating channel 24 from the entry channel 33, the exit channel 34 and the exhaust channel 36. The membrane 37 is supported on an exhaust ring 38 that is fitted into the valve body 31. An O-ring seal 39 makes it possible to ensure tightness between the body of the valve 31 and the exhaust ring 38. A plug 40, screwed onto the valve body 31, makes it possible to keep the membrane 37 in position against the exhaust ring 38.

A gauge 42 of an overall cylindrical shape is located between the actuating channel 24 and the entry channel 33, one end 42a of the gauge 42 being housed in a central orifice 43 of the membrane 37.

The gauge 42 is pierced by a longitudinal hole 44 that does not discharge on the side of the end 42a. The hole 44 is crossed perpendicularly by a hole 45. Two grooves 46, for example of triangular cross-section, discharge into the hole 45. The passage between the grooves 46 and the membrane 37 is thus calibrated to greatly reduce the flow rate between the entry channel 33 and the actuating channel 24.

The valve 6 includes a flap 47 that is integral with the gauge 42. The flap 47 can move in a recess 48 of the valve body 31, between a first position shown in FIGS. 1 and 3 and a second position shown in FIG. 8. The entry channel 33, the exit channel 34 and the exhaust channel 36 discharge into the recess 48. In the first position, the flap 47 is supported on the edge 50 of the entry channel 33 and prevents the circulation of water between the entry channel 33 and the recess 48. In this position, the flap 47 is spaced apart from an edge 51 of the exhaust ring 38, and the circulation of water is possible between the exit channel 34 and the exhaust channel 36. In the second position, the flap 47 is supported on the edge 51 and prevents the circulation of water between the recess 48 and the exhaust channel 36. In this position, the flap 47 is spaced apart from the edge 50, and the circulation of water is possible between the entry channel 33 and the exit channel 34.

With reference to FIGS. 4 to 6, the flushing mechanism 2 will now be presented in more detail.

The flushing mechanism 2 comprises an overflow tube 53 that is mounted in translation in a casing (not shown). The overflow tube 53, on its lower end, bears a head 54 that is provided with a flat peripheral seal, which form a closing flap 56, working with a cap 57.

When the closing flap 56 is spaced apart from the cap 57, the water contained in the flushing tank flows into a toilet bowl (not shown).

The flushing mechanism 2 comprises a float 58 that is mounted on a micrometer screw 59 for fine height adjustment that adjusts the amount of water delivered. The screw 59 comprises an upper screw head 60, and its lower end 59a is provided with a ball-and-socket joint 61 of a lever 62 whose end opposite the ball-and-socket joint 61 is articulated around a fixed axis A relative to the casing. The lever 62 bears a lug 63 that works with a cam 64 that is carried by the overflow tube 53 in a manner that will be described in detail below.

The jack 3 comprises a body 66 and a piston 67, the piston 67 being attached to a rod 68. The body 66 defines, in cooperation with the piston 67, a chamber 69. The chamber 69 comprises a supply orifice 70 that is connected to the exit channel 34 of the valve 6 by the pipe 30. The rod 68 is coupled to the overflow 53. The piston 67 is acted upon by a spring (not shown) in a direction that tends to reduce the volume of the chamber 69, i.e., toward the bottom in the figures.

With reference to FIG. 7, the connection of the pipes 25 and 30 will now be described in more detail. The pipes 25 and 30 are pneumatic-type flexible pipes. The means allowing mechanical support and tightness of the pipes 25 and 30 are integrated in the control unit 5, the valve 6 and the jack 3, respectively. Mechanical support is ensured by two half-shells 95 that grip the pipes 25, 30 respectively. The half-shells 95 comprise grooves 98 for keeping the pipes 25, 30 respectively in position. A water main part 97 is arranged within the half-shells 95. An O-ring seal 96 ensures tightness between the pipe 25, 30 respectively, and the part 97.

An actuating operation of the flushing mechanism 2 by the actuating device 1 will now be described.

In the rest position (FIGS. 1 to 6), the plunger 9 is in the up position, i.e., it projects from the rosette 7.

In this position, the flap 29 is kept against the groove 27 by the leaf 17 and prevents the circulation of water between the passage 23 and the evacuation hole 26. The closing diameter is, for example, roughly 0.6 mm. To ensure tightness at a test pressure of roughly 16 bar, the leaf 17, for example, applies a pressure that is equivalent to 200 to 300 g to the flap 28 via the elbow 16.

In this position, the water that is contained in the actuating pipe 25, which is supplied via the gauge 42, applies pressure to the top of the membrane 37. This has the effect of keeping the flap 47, via the gauge 42, in the first position. The chamber 69 is essentially empty, and the piston 67 is kept elastically in the down position.

Starting from this position, when a user pushes on the plunger 9 so as to move the plunger 9 up to an operating position in which the plunger is essentially in the plane of the rosette 7 (FIG. 8), this has the effect of lifting the flap 29 off the groove 27 as the leaf 17 is compressed. The flap 29 is, for example, lifted roughly 1 to 1.5 mm off the groove. In this position, the water that is contained in the actuating pipe 25 is evacuated via the evacuation hole 26 and the pressure applied to the top of the membrane 37 decreases. The flap 47 and the gauge 42 are moved upward by the pressure in the entry channel up to the second position of the flap 47 (FIG. 8). In this position, the chamber 69 of the jack 3 is filled by the exit channel 34 that has been supplied by the entry channel 33. The piston 67 and the rod 68 slide in the jack body 66, which has the effect of moving the overflow tube 53 upward; this entails opening the flap 56. The flap 56 is, for example, spaced apart from the seat of the cap 57 by a height of roughly 20 mm.

At the same time, the cam 64 slides onto the lug 63 of the lever 62 until the lug 63 comes to rest under a shoulder 72 that is formed by this cam 64 (FIGS. 9 and 10). Tilting of the lever 62 is ensured by the float 58 that pushes the screw 59 toward the top.

When the user releases the plunger 9, the flap 29, acted upon by the leaf 17, moves until it is supported against the seat 22a. In this position, the flap 29 is supported against the groove 27 and prevents the circulation of water between the passage 23 and the evacuation hole 26. The pressure of the water contained in the actuating pipe 25 rises, which results in deformation of the membrane 37. The flap 47 is moved up to the first position. In this position, the flap 47 prevents circulation between the entry channel 33 and the exit channel 34, but allows circulation between the exit channel 34 and the exhaust channel 36. This allows the water that is contained in the chamber 69 of the jack 3 to flow into the flushing tank. This flow ends when the chamber 69 is empty, which corresponds to the down position of the piston 67.

The float 58 locks the overflow tube 53 and releases it consecutively upon the lowering of the water level in the tank. The float 58 as it is lowered makes the lever 62 pivot. The lug 63 then moves away from the shoulder 72, and the overflow tube 53 drops freely, interrupting the emptying.

Thus, to trigger the flushing mechanism 2, the user must simply apply a force that allows the flap 29 to move. In this case, the pressure in the water system makes it possible to raise the overflow 53. In other words, when the user applies a relatively weak force to the plunger 9, the pressure in the water system is used to generate a greater force allowing the flushing mechanism 2 to be triggered. The pressure in the water system thus makes it possible to assist actuation of the flushing mechanism. The actuating device 1 thus makes it possible to reduce the force and the stroke of the plunger 9 and to simplify the transmission to the flushing mechanism 2. The connection of the plunger 9 to the flushing mechanism 2 is very flexible and can be very long, which facilitates the installation of the actuating device 1.

The stroke of the plunger 9 is, for example, roughly 1.5 mm. Due to the fact that the stroke is short, the diameter of the plunger 9 is no longer required to be fitted into the hole, typically with a diameter that is equal to 40 mm, of the tank cover. It is thus possible to keep a rosette flat over a very large diameter, thus allowing much more room for the pins. This allows a wide choice in implementation of the rosette-plunger combination. For example, the rosette-plunger combination can be encompassed by a sealed, flexible casing bearing a relief symbolizing the position of the plunger on the top. Another possibility consists in using a colored flexible keypad of the electronic control keypad type.

The flushing mechanism 2 shown in FIGS. 1 to 12 is a so-called double flush mechanism, i.e., it allows the evacuation of two different water volumes at the discretion of the user.

The plunger 9 is a so-called low-flush plunger. The actuating unit 4 comprises a second so-called high-flush plunger 80, which comprises an axial extension 81 that can slide into the threaded projection 8.

The actuating rod 21 comprises one end 21a supported against the lower edge of the extension 81. The opposite end 21b of the actuating rod comprises an elbow 20 that extends toward the periphery of the box 11.

The control unit 5 comprises a second seat support 82 bearing a seat 82a. The seat support 82 comprises a passage 83. The passage 83 is connected to an actuating channel of a second valve (not shown) by an actuating pipe (not shown). The passage 83 is able to communicate with an evacuation hole 84 of the lower surface 11a of the box 11 via a groove 85 that discharges into the seat 82a. The evacuation hole 84 discharges, for example, into the flushing tank.

The elbow 20 comprises a recess 86, located to the right of the groove 85, in which a valve 87 is housed. In the rest position, the leaf 17 keeps the elbow 20 against the seat 82a. In this position, the valve 87 is supported against the groove 85 and blocks communication between the passage 83 and the evacuation hole 84.

The valve joined to the high-flush plunger 80 is similar to the valve 6.

The flush mechanism 2 comprises a high-flush float 90 that can pivot around a stationary axis B relative to the casing, which is mounted on one side essentially diametrically opposite the low-flush float 58 relative to the overflow tube 53. The float 90 is arranged lower than the float 58. The float 90 is provided with a lug 91 that works with a cam 92 carried by the overflow tube 53. The lug 63 is located lower than the lug 91.

The flush mechanism 2 comprises a second jack 93 that is similar to the jack 3. The stroke of the high-flush piston is greater than the stroke of the low-flush piston 68, such that the high-flush piston can move the flap 56 by a greater height.

An actuating operation of the flushing mechanism 2 by pushing on the plunger 80 is similar to an actuating operation of the flushing mechanism 2 by pushing on the plunger 9.

In this case, the lug 91 comes to rest under a shoulder 94 of the cam 92, such that the high-flush float 90 locks the overflow tube 53. The overflow tube 53 is moved to a higher emptying position that corresponds to high-flush emptying. The flap 56 is, for example, spaced apart from the seat of the cap 57 by a height of roughly 26 mm. As before, the overflow tube 53 is only released when the water level in the tank releases the float 90 that, as its pivots, moves the lug 91 away from the cam 92. The overflow tube 53 then drops suddenly into the blocking position, the amount of water emptied corresponding to a high flush.

Other variants are possible. For example, the actuating device 1 can be used to actuate the emptying of a single or double sink, a bathtub, a washbasin, a bidet or any other sanitary appliance requiring a water evacuation mechanism that can be triggered.

While the invention has been described in relation to one particular embodiment, it is quite apparent that it is in no way limited thereto and that it includes all technical equivalents of the described means as well as their combinations if they fall within the scope of the invention.

1. Hydraulic actuating device (1) for actuating a water evacuation mechanism (2), said hydraulic actuating device comprising an actuating unit (4) with plunger(s), characterized in that it comprises:
a control unit (5) that can be integrated with the actuating unit,
at least one three-way hydraulic valve (6) supplied by a water distribution system and controlled hydraulically by the control unit (5), and
at least one single-action hydraulic jack supplied via the valve and ensuring the triggering of said water evacuation mechanism by raising a closing flap.

2. Hydraulic actuating device according to claim 1, wherein said hydraulic valve (6) comprises an entry channel (33) that is designed to be connected to said water distribution system, an exit channel (34) designed to be connected to the chamber (69) of said hydraulic jack, and an exhaust channel (36), said hydraulic valve comprising a flap (47) that can move between a first position in which it allows the circulation of water from said exit channel (34) toward said exhaust channel (36), and a second position in which it allows the circulation of water from said entry channel (33) to said exit channel (34), said hydraulic jack being able to ensure the raising of said closing flap or plug when said flap is in said second position.

3. Hydraulic actuating device according to claim 2, wherein said entry channel (33) supplies an actuating channel (24) of said hydraulic valve (6) via a gauge (42), said actuating channel being designed to be connected to the actuating pipe (25) of said hydraulic actuating device, said plunger (9, 15) being able to move between a rest position in which the water that is contained in said actuating pipe can apply to said flap (47) a pressure that is sufficient to keep said flap in the first position, and an operating position in which at least a portion of the water contained in said actuating pipe (25) is evacuated' from said actuating pipe to allow displacement of said flap (47) to the second position.

4. Hydraulic actuating device according to claim 3, wherein it comprises an actuating rod (15), said plunger having an extension (10) supported on one end (15a) of the actuating rod, said actuating rod being elastically pushed toward a rest position corresponding to the rest position of said plunger, said actuating rod being integral in translation with an operating flap (29), said operating flap being arranged so as to prevent evacuation of water from a passage (23) discharging into said actuating pipe when said actuating rod is in the rest position and to allow the evacuation of water from said passage when said actuating rod is in said operating position.

5. Hydraulic actuating device according to claim 3, wherein said actuating channel (24) discharges into a first recess (32) of a valve body (31) of said hydraulic valve, an elastic membrane (37) being located in the recess (32) so as to separate the actuating channel (24) from the entry channel (33), the exit channel (34) and the exhaust channel (36), one end of said gauge (42) being housed in an orifice (43) of said membrane (37).

6. Hydraulic actuating device according to claim 5, wherein said flap (47) is integral with the gauge (42), the flap (47) being movable into a second recess (48) of the valve body into which the entry channel (33), the exit channel (34) and the exhaust channel (36) discharge, the flap (47) in the first position being supported on a first edge (50) so as to prevent the circulation of water between the entry channel (33) and said second recess (48), and, in the second position, supported on a second edge (51) so as to prevent the circulation of water between said second recess (48) and the exhaust channel (36).

7. Hydraulic actuating device according to claim 1, wherein said hydraulic actuating device is used to actuate a sanitary flushing mechanism (2).

8. Hydraulic actuating device according to claim 7, wherein said flushing mechanism is a double-flushing mechanism, said hydraulic actuating device comprising a second three-way hydraulic valve supplied by said water distribution system and controlled by said control unit, the actuating unit comprising two plungers, each actuating one of the hydraulic valves, said hydraulic actuating device comprising a second, single-action hydraulic jack supplied via said second valve and ensuring the triggering of said water evacuation mechanism by raising said closing flap, said second jack comprising a piston with a stroke different from the stroke of the piston of said jack, in such a way that the closing flap is raised by a different height when it is raised by said second jack and when it is raised by said jack.

9. Hydraulic actuating device according to claim 1, wherein said hydraulic actuating device is used to actuate a mechanism for emptying a basin, such as a tub, a washbasin, a bidet or a sink.

10. Hydraulic actuating device according to claim 4, wherein said actuating channel (24) discharges into a first recess (32) of a valve body (31) of said hydraulic valve, an elastic membrane (37) being located in the recess (32) so as to separate the actuating channel (24) from the entry channel (33), the exit channel (34) and the exhaust channel (36), one end of said gauge (42) being housed in an orifice (43) of said membrane (37).
